(19) United States
(12) Patent Application Publication
(10) Pub. No.: US 2024/0217467 A1
(43) Pub. Date: Jul. 4, 2024

(54) BEAM FRAME FOR BUMPER BACK BEAM OF VEHICLE

(71) Applicant: Dongwon Metal Co., Ltd., Gyeongsan-si (KR)

(72) Inventors: Yun Guk LEE, Daegu (KR); Hong Gyu HWANG, Seongju-gun (KR); Won PARK, Daegu (KR); In Kyu CHOI, Gyeongsan-si (KR); Ho Jun LEE, Daegu (KR)

(21) Appl. No.: 18/091,445

(22) Filed: Dec. 30, 2022

(51) Int. Cl. B60R 19/18

(52) U.S. Cl. CPC B60R 19/18; B60R 2019/1806

(57) ABSTRACT

A beam frame for a bumper back beam of a vehicle includes: a front plate and a rear plate which have a plate shape and are spaced in parallel to each other; a pair of end girder plates which function as connection bridges for integrally connecting the front plate and the rear plate, each of the end girder plates being connected to the front plate at a first connection angle therebetween and connected to the rear plate at a second connection angle therebetween; and an inner girder plate disposed between the end girder plates, connected to the central point of the width of the front plate at a right angle, and connected to the central point of the width of the rear plate at a right angle.

### BACKGROUND OF THE INVENTION

### 1. Field of the Invention

The present disclosure relates to a beam frame for a bumper back beam of a vehicle and, more particularly, a beam frame having an optimized sectional shape as a base member for a back beam which is a protective member cooperating with a bumper attached to the front side or the rear side of a vehicle in order to secure the safety of a passenger and protect a vehicle body including a chassis at the time of a vehicle collision.

### 2. Description of the Prior Art

A vehicle bumper is an essential member for safety, is installed at the front side or the rear side of a vehicle chassis in order to protect a vehicle body including the chassis and a passenger, and performs an important function of protecting chassis, an a engine and various electric/electronic components installed in an engine room, and furthermore, a driver, a passenger, and the like. Therefore, a vehicle bumper is an essential element and should satisfy the shock absorption requirements according to limitation regulations of each country.

A vehicle bumper includes, as an impact absorption system, a fascia as a front bumper forming the outer shell of a bumper, a cushion foam which is an energy absorbing member made of a synthetic resin material which has various shapes, maintains the shape of a front bumper, and has functions of mitigating an impact at the time of a collision and restoring the shape, and a back beam as an element for supporting the foam and absorbing energy at the time of a collision through elastic deformation or plastic deformation so as to protect mechanical components or electric/electronic components positioned at the rear side, and secure the safety of a passenger.

A back beam provided for this purpose can be manufactured in various shapes by using various materials.

A back beam may be manufactured by press-processing a metal or a synthetic resin material by using a die having the entire shape of the back beam so as to form a back beam having a specific single/independent shape, and by welding multiple separated metal parts for a back beam to each other so as to form a complete back beam.

Moreover, in consideration of processability and production cost, a back beam manufacturing method of extruding a material such as aluminum by using a die so as to manufacture an extruded beam frame having a continuously long pipe shape, cutting the extruded beam frame in a required length, and then bending or cutting as a post-processing the cut beam frame to correspond to the front shape of a vehicle, is widely used.

The present disclosure relates to a beam frame which has a sectional shape of a back beam as a base member, and is extruded to have a continuously long pipe shape by using a die and is then processed into a final back beam.

A beam frame extruded in the shape of an elongated pipe may have various lengthy axial sectional shapes having various sectional moduli, for optimization of processability, manufacturing cost, and impact absorption power.

Generally, a beam frame for a back beam may have a pipe-shaped sectional shape having a substantially rectangular cross-sectional shape, and since the sectional area and the sectional modulus thereof change according to the sectional shape and configuration of a pipe, the impact absorption power, that is, the energy absorption value, which is actually obtained at the time of a vehicle collision, varies greatly.

Beam frames having various sectional shapes enabling optimized impact absorption by a back beam within a limited sectional shape have been devised.

### PRIOR ART DOCUMENT

### Patent Document

(Patent Document 0001) U.S. Pat. No. 11,148,622
(Patent Document 0002) U.S. Pat. No. 10,632,946
(Patent Document 0003) U.S. Pat. No. 10,259,410
(Patent Document 0004) U.S. Pat. No. 8,668,234

In connection with a prior art relating to a beam frame for a back beam of a vehicle, bumper beams are disclosed in U.S. Pat. No. 11, 148, 622 (Gilles Brun et al.), U.S. Pat. No. 10, 632, 946 (Amar Rajendra Jadhavet al.), U.S. Pat. No. 10,259,410 (Atsuo Koga et al.), and U.S. Pat. No. 8,668,234 (Takunori Yamaguchi et al.).

A bumper beam disclosed in US patent No. 10, 632, 946 (Amar Rajendra Jadhavet al.) will be described with reference to FIG. 18. As illustrated in FIG. 18, a bumper beam PB includes a top wall and a bottom wall spaced apart from each other, a pair of first geometric structures and a pair of second geometric structures arranged between the top wall and the bottom wall to be spaced apart from each other. One and the other of first geometric structures are respectively connected to the top wall and the bottom wall, one and the other of the second geometric structures are respectively connected to the top wall and the bottom wall, and thus the first geometric structures and the second geometric structures function as a connection body.

That is, the bumper beam disclosed in the U.S Patent has multiple polygonal geometric structures connected to the top wall and the bottom wall.

However, the bumper beam has the following problems.

Since the geometric structures have a complicated shape, it may be difficult to implement a die for extrusion, and thus cost may increase. In addition, when an extrusion process is performed using an implemented die, due to the complicated structure of the die, the die may be greatly worn, and substantial extrusion power may be required.

The performances compared by testing the present disclosure and the relative prior art will be described later.

### SUMMARY OF THE INVENTION

The present disclosure is to provide a beam frame capable of solving the technical and economic problems of the prior arts.

The present disclosure is to provide a sectional shape of a beam frame, by which an impact force (impact energy) is instantly dispersed in multiple stages within very short time, to reduce the damage of a chassis of a vehicle and improve the safety of a passenger.

A beam frame for a bumper back beam of a vehicle according to an exemplary embodiment of the present disclosure is extruded to have a sectional shape, the beam frame including: a front plate and a rear plate which have a plate shape and are spaced in parallel to each other; a pair of end girder plates which function as connection bridges for integrally connecting the front plate and the rear plate, each of the end girder plates being bent and being connected to the front plate at a first connection angle therebetween and connected to the rear plate at a second connection angle therebetween, the first connection angle being an angle between the front plate and an inner surface of the each of the end girder plates and being an angle selected in a range between a right angle and an obtuse angle, the second connection angle being an angle between the rear plate and the inner surface and being an angle selected in a range between a right angle and an acute angle, the inner surface facing a central point of the width of the front plate and a central point of the width of the rear plate; and an inner girder plate disposed between the end girder plates, connected to the central point of the width of the front plate at a right angle, and connected to the central point of the width of the rear plate at a right angle.

A beam frame for a bumper back beam of a vehicle according to an exemplary embodiment of the present disclosure is extruded to have a sectional shape, the beam frame including: a front plate and a rear plate which have a plate shape and are spaced apart in parallel to each other; a pair of end girder plates which function as connection bridges for integrally connecting the front plate and the rear plate, each of the end girder plates being bent and being connected to the front plate at a first connection angle therebetween and connected to the rear plate at a second connection angle therebetween, the first connection angle being an angle between the front plate and an inner surface of the each of the end girder plates and being an angle selected in a range between a right angle and an obtuse angle, the second connection angle being an angle between the rear plate and the inner surface and being an angle selected in a range between a right angle and an acute angle, the inner surface facing a central point of the width of the front plate and a central point of the width of the rear plate; and an inner girder plate disposed between the end girder plates, connected to a central point of the width of the front plate at a right angle, and connected to a central point of the width of the rear plate at a right angle, wherein each of the end girder plates includes a reinforced part which is disposed between the front plate and the rear plate and at which said each of the end girder plates is bent, a first buckling part extending from the front plate to the reinforced part, and a second buckling part extending from the rear plate to the reinforced part, each of the end girder plates is bent at the reinforced part at a bent angle which is larger than 180 degrees at an inside thereof facing the inner girder plate, and each of the first buckling part and the second buckling part has a shape of a plate.

A beam frame for a bumper back beam of a vehicle according to another exemplary embodiment of the present disclosure is extruded to have a sectional shape, the beam frame including: a front plate and a rear plate which have a plate shape and are spaced apart in parallel to each other; a pair of end girder plates which function as connection bridges for integrally connecting the front plate and the rear plate, each of the end girder plates being connected to the front plate at a right angle and connected to the rear plate at a right angle; and an inner girder plate disposed between the end girder plates, connected to a central point of the width of the front plate at a right angle, and connected to a central point of the width of the rear plate at a right angle.

A beam frame for a bumper back beam of a vehicle according to another exemplary embodiment of the present disclosure is extruded to have a sectional shape, the beam frame including: a front plate and a rear plate which have a plate shape and are spaced apart in parallel to each other; a pair of end girder plates which function as connection bridges for integrally connecting the front plate and the rear plate, each of the end girder plates being connected to the front plate at a right angle and connected to the rear plate at a right angle; and a pair of inner girder plates configured to extend from a central point of the width of the front plate toward a central point of the rear plate, and integrally connected to the rear plate while being spread at a spread angle selected from 90 degrees or less.

According to the present disclosure, a beam frame is easily buckled when an impact force is applied to a vehicle, so that the beam frame can absorb a large impact force (i.e., much impact energy) through buckling.

In addition, the present disclosure provides a sectional shape of a beam frame, by which an impact force (impact energy) is instantly dispersed in multiple stages within very short time, to reduce the damage of a chassis of a vehicle and improve the safety of a passenger.

Furthermore, the present disclosure enables reduction of the input amount of a material for extrusion while increasing the strength of a beam frame.

In addition, the present disclosure reduces production power for extrusion, prevents the clogging a die for extrusion, and reduces the wearing of a die (an extruder), thereby improving the productivity of manufacturing a back beam.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a perspective view showing an exemplary back beam, which is applied to a front bumper part of a vehicle and to which a beam frame of the present disclosure is applied;

FIG. 2 is a partial perspective of a beam frame seen from the front side thereof according to an exemplary embodiment of the present disclosure;

FIG. 3 is a cross sectional view of a beam frame taken along line A-A in FIG. 2 according to an exemplary embodiment of the present disclosure;

FIG. 4 is a cross sectional view taken along line A-A in FIG. 2 for explaining an operation of the beam frame in FIG. 3;

FIG. 5 illustrates, in the cross-section taken along line A-A in FIG. 2, buckling of the beam frame after an impact test of sectional strength analysis of a back beam to which the beam frame in FIG. 3 is applied;

FIG. 6 is a graph showing an entry displacement versus a reaction force according to a strength analysis of a back beam to which the beam frame in FIG. 3 is applied;

FIG. 7 is a graph showing an entry displacement versus an energy absorption value according to a strength analysis of a back beam to which the beam frame in FIG. 3 is applied;

FIG. 8 is a cross sectional view taken along line A-A in FIG. 2, which shows an employable beam frame according to a modified example of the present disclosure;

FIG. 9 is a partial perspective of a beam frame seen from the front side thereof according to another exemplary embodiment of the present disclosure;

FIG. 10 is a cross sectional view of another exemplary embodiment, taken along line A-A in FIG. 2;

FIG. 11 is a cross sectional view of an employable modified example, taken along line A-A in FIG. 2;

FIG. 12 is a graph showing an entry displacement versus a reaction force according to a strength analysis of a beam frame of another exemplary embodiment;

FIG. 13 is a graph showing an entry displacement versus an energy absorption value according to a strength analysis of a back beam according to a strength analysis of a beam frame of another exemplary embodiment;

FIG. 14 is a partial perspective of a beam frame seen from the front side thereof according to another exemplary embodiment of the present disclosure;

FIG. 15 is a cross sectional view according to another exemplary embodiment, taken along line A-A in FIG. 2;

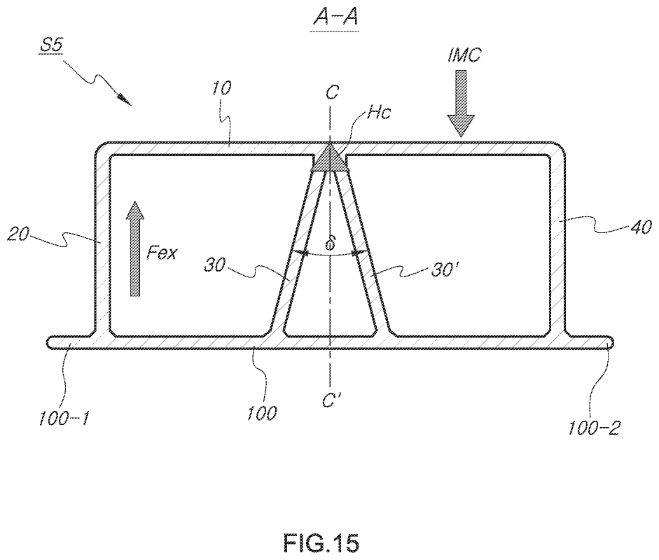

FIG. 16 is a graph showing an entry displacement versus a reaction force according to a strength analysis of a beam frame of another exemplary embodiment;

FIG. 17 is a graph showing an entry displacement versus an energy absorption value according to a strength analysis of a beam frame of another exemplary embodiment;

FIG. 18 is a cross sectional view of a relative prior art, taken line A-A in FIG. 2, for explaining exemplary embodiments and modified examples of the present disclosure, through comparison with the relative prior art;

FIG. 19 illustrates, in the cross-section taken along line A-A in FIG. 2, buckling after RCAR impact tests of a bumper back beam of the relative prior art for explaining exemplary embodiments and modified examples of the present disclosure, through comparison with the relative prior art; and

FIG. 20 is a table showing results of RCAR impact tests of a beam frame of exemplary embodiments and modified examples of the present disclosure, through comparison with the relative prior art.

### DETAILED DESCRIPTION OF THE EXEMPLARY EMBODIMENTS

Hereinafter, the configuration and the operation of a beam frame for a bumper back beam of a vehicle according to exemplary embodiments of the present disclosure will be described in detail with reference to the accompanying drawings.

In connection with reference numerals of elements in modified examples which have the same technical idea as that of exemplary embodiments of the present disclosure, the same reference numerals will be used to refer to the same elements.

A main technical subject in the design of a beam frame for a back beam of a vehicle according to the present disclosure is to secure a sectional shape which enables easy buckling (or collapse) at the time of a vehicle collision, can maximally absorb the impact force when buckling occurs, and can absorb the impact force in a temporally dispersed way, thereby maximally guaranteeing the safety a passenger and protecting a chassis.

By maximizing the section modulus of a beam frame and minimizing the sectional area thereof, the durability of the beam frame against mechanical deformation can be enhanced, the strength of the beam frame can be optimized, loss of raw materials can be reduced, power for extrusion can be minimized, and thus production cost thereof can be reduced.

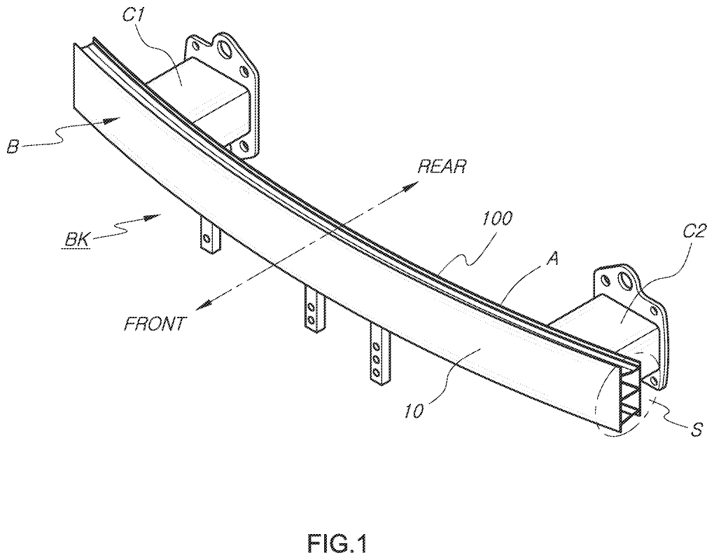

As noted from FIG. 1 illustrating a beam frame B according to an exemplary embodiment of the present disclosure, a bumper beam or a back beam BK installed inside a front bumper or a rear bumper of a vehicle is made by bending and chamfering the beam frame B, is fixed to a chassis (not shown) of a vehicle by a pair of crush caps C1 and C2, and provides a basic configuration in cooperation with an impact absorption foam (not shown) in front of the beam frame B.

The beam frame B may be a base member for producing such a back beam BK, and the beam frame B may be formed by extruding aluminum, for example, such as AL-Mg—Si-based A6082 having excellent formability and strength, through a die designed to enable the beam frame to have a specific sectional shape, and may have a continuous long bar shape obtained through quenching, stretching, aging, and bending processes which are post-processes. However, the beam frame is not significantly limited to specific materials and physical properties, and thus a synthetic resin or the like may be employed as its material.

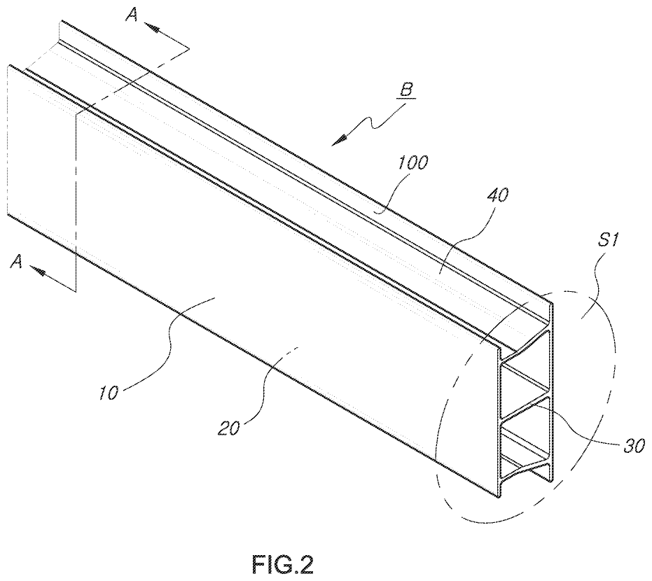

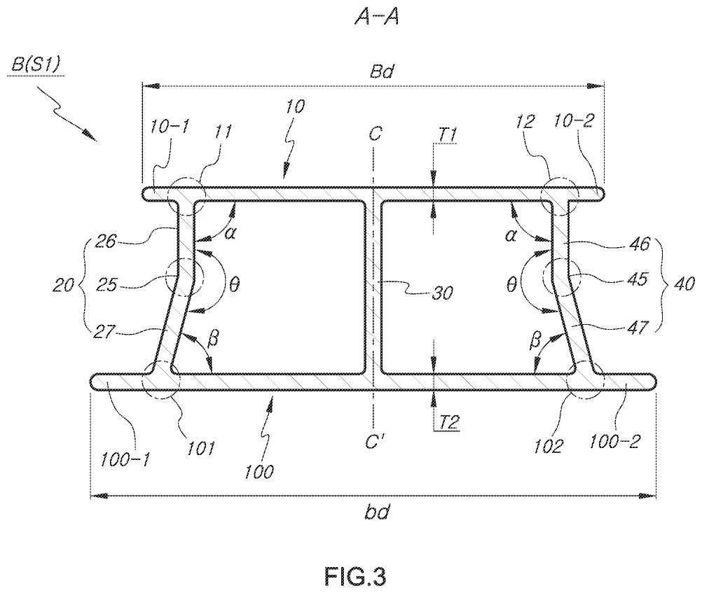

FIG. 2 is a partial perspective of a beam frame B of an exemplary embodiment of the present disclosure, and FIG. 3 is a cross sectional view showing a sectional shape S of a beam frame B taken along line A-A in FIG. 2. When the beam frame B is made, a material is extruded along a straight-line, is cut, and is then, as shown in the perspective view of FIG. 1, bent to have a required curvature according to a vehicle design, so that the beam frame as a final product is obtained.

FIG. 3 illustrates a sectional shape S of the beam frame B according to an exemplary embodiment of the present disclosure, and the sectional shape S may be obtained through research and development and repeated experiments, and may be practically applicable thereto.

A front plate 10 as a plate-shaped part, which faces the side (the front) of a front bumper of a vehicle, and a rear plate 100 facing the side (the rear) of a chassis of a vehicle may be a pair of plate-shaped bodies facing each other in parallel, and may function as an impact absorption part to which an external impact is actually applied and which transfers the impact force to the chassis of the vehicle.

In view of the occurrence of buckling of the beam frame B by an impact force from the outside and the mountability to a chassis of a vehicle, generally, the front plate 10 may be designed to have a thickness T1 smaller than the thickness T2 of the rear plate 100, but it is not an important technical point of view.

The beam frame B may include three separate connection bridges which are actually buckled and connect the front plate 10 and the rear plate 100 which are spaced parallel. According to the present disclosure, the connection bridges may include a pair of end girder plates 20 and 40 at the sides of opposite ends of each of the front plate 10 and the rear plate 100, and an inner girder plate 30 at the center position between the end girder plates 20 and 40, and the beam frame B may be formed by integrally extruding the end girder plates 20 and 40 and inner girder plate 30 as a plate-shaped body.

The end girder plates 20 and 40 may be positioned at both sides with reference to the central point C of the width Bd of the front plate 10 to be spaced apart from each other, and each of the end girder plates may be a plate member having a first connection angle α. Here, the first connection a is an angle between the front plate 10 and an inner surface of the each of the end girder plates 20 and 40 and is an angle selected in a range between a right angle and an obtuse angle, and the inner surface faces a central point of the width C of the front plate 10.

The end girder plates 20 and 40 may extend from the front plate 10 to the rear plate 100 parallelly facing the front plate, and may be connected to the front plate 10 and the rear plate 100 to be left/right symmetric while having a second connection angle β. Here, the second connection angle β is an angle between the rear plate 100 and an inner surface of the each of the end girder plates 20 and 40 and is an angle selected in a range between a right angle and an obtuse angle.

The end girder plates 20 and 40, which is integrally extruded and connect the front plate 10 and the rear plate 100, are connected to portions of the front plate 10 and the rear plate 100, the portions are selectable between opposite ends of each of the front plate 10 and the rear plate 100, and thus the end girder plates 20 and 40 are positioned inside the front plate 10 and the rear plate 100. Therefore, as illustrated in FIG. 3, each of the front plate 10 and the rear plate 100 may further include extension flanges 10-1 and 10-2 and 100-1 and 100-2 extending from the portions to outermost ends of each of the front plate 10 and the rear plate 100.

In the above configuration, each corner of the branch portion where the pair of end girder plates 20 and 40, and the inner girder plate 30, the front plate 10 and the rear plate 100 meet and is integrally molded is shown in FIG. 3 And below figures, it is preferable to further have a rounded curvature portion R without meeting an acute angle or an obtuse angle. This is because the concentration of stress in this branch portion is prevented and strength is increased, so that the leverage operation described later can be performed more smoothly.

According to the present disclosure, the beam frame B for a bumper back beam BK of a vehicle, which is extruded to have a sectional shape, may include: the front plate 10 and a rear plate 100 which have a plate shape and are spaced parallel to each other; the pair of end girder plates 20 and 40 which function as connection bridges for integrally connecting the front plate 10 and the rear plate 100, each of the end girder plates 20 and 40 being bent and being connected to the front plate 10 at the first connection a angle therebetween and connected to the rear plate 100 at the second connection angle β therebetween, the first connection angle α being an angle between the front plate 10 and an inner surface of the each of the end girder plates 20 and 40 and being an angle selected in a range between a right angle and an obtuse angle, the second connection angle β being an angle between the rear plate 100 and the inner surface and being an angle selected in a range between a right angle and an acute angle, the inner surface facing a central point C of the width Bd of the front plate 10 and a central point C′ of the width bd of the rear plate 100; and the inner girder plate 30 disposed between the end girder plates 20 and 40, connected to the central point C of the width Bd of the front plate 10 at a right angle, and connected to the central point C′ of the width bd of the rear plate 100 at a right angle.

Additionally, the end girder plates 20 and 40 may include reinforced parts 25 and 45, respectively. The reinforced parts 25 and 45 may be formed at the central portions of the end girder plates 20 and 40 which have a plate shape and extend from the front plate 10 while having the first connection angle α selected from the range between a right angle and an obtuse angle, and may be bent toward the inner girder plate 30 to have a bending angle θ larger than 180 degrees. Therefore, the end girder plates 20 and 40 may have relatively improved strength by the geometric shape of the reinforced parts 25 and 25 by the bending angle θ, and have an enhanced strength against buckling.

By the geometric shape of the reinforced parts 25 and 45, the reinforced parts 25 and 45 may have a section modulus higher than buckling parts 26 and 27 and 46 and 47 of the end girder plates 20 and 40, which are flat plate parts and are easily buckled.

In addition, connection parts, in which the front plate 10 and the end girder plates 20 and 40 are connected, may include starting reinforced parts 11 and 12 having a geometric factor due to the formation of the first connection angle α, and connection parts, in which the rear plate 100 and the end girder plates 20 and 40 are connected, may include ending reinforced parts 101 and 102 having a geometric factor due to the formation of the second connection angle β.

Portions except for the reinforced parts 25 and 45 of the end girder plates 20 and 40 may be formed as flat plate parts having a relatively small section modulus so as to form first buckling parts 26 and 46 and second buckling parts 27 and 47, in which buckling actually occurs with high probability at the time of a vehicle collision.

The inner girder plate 30, which is uprightly connected to the central point C of the width Bd of front plate 10, may extend up to the rear plate 100 at a right angle and be connected to the central point C′ of the width of the rear plate 100.

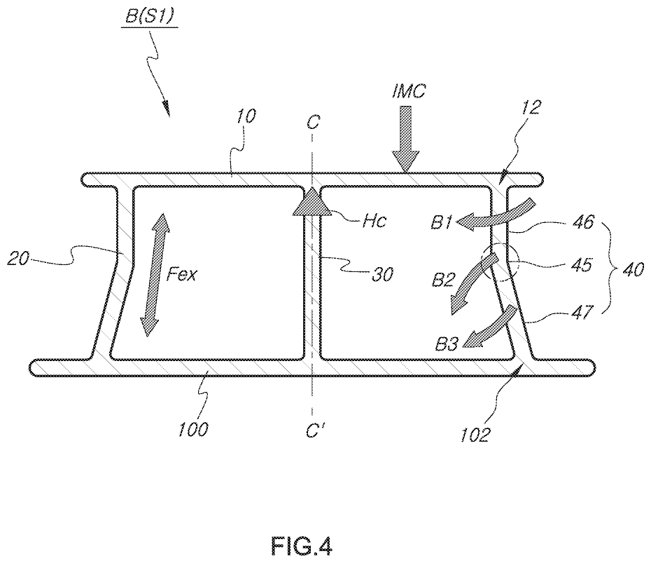

As illustrated in FIG. 4, the inner girder plate 30 may connect the middle parts of the front plate 10 and the rear plate 100 and may form a hinge center Hc for the left and right end girder plates 20 and 40 as the center of a seesaw, and thus the front plate 10 may be leveraged with reference to the hinge center Hc.

The inner girder plate 30 may be a member which cooperates with the end girder plates 20 and 40 at opposite ends thereof, is deformed by unpredictable buckling at the time of a vehicle collision, and additionally absorbs impact.

According to an exemplary embodiment of the present disclosure, when an impact is applied to the beam frame B having the sectional shape S from the front, the impact force transferred to the front plate 10 may be transferred to the rear plate 100 through the end girder plates 20 and 40 and inner girder plate 30, and at the same time, the end girder plates 20 and 40 and inner girder plate 30 may be buckled.

The starting reinforced parts 11 and 12, with which the front plate 10 and the end girder plates 20 and 40 are in contact, may have a relatively restrained buckling, the front plate 10 may move toward the rear plate 100. Therefore, in the first buckling parts 26 and 46 which are the front flat plate parts, except for the reinforced parts and 45 of the end girder plates 20 and 40, buckling may be started.

The buckling, which is further proceeded from the first buckling parts 26 and 46, may further proceed toward the rear plate 100 while pulling the reinforced parts 25 and 45 of which deformation is restrained due to the geometric shape of the end girder plates 20 and 40. As the process proceeds further, additionally, the second buckling parts 27 and 47, which are the rear flat plate parts of the end girder plates 20 and 40, may be buckled, and thus while having time lapse, multi-stage continuous buckling may be achieved and impact energy resulting therefrom may be absorbed.

During this process, at the time of collision, the central inner girder plate 30 between the front plate 10 and the rear plate 100 may be buckled in an unpredictable deformation shape to help impact absorption.

When a vehicle collision occurs, the probability that the impact center force (IMC) due to the collision is accurately applied to the central point C of the width Bd of the front plate 10, is very low. As in the right part of FIG. 4, in most cases, deformation of the beam frame B, which is generally generated, may be concentrated on either of both ends of the end girder plates 20 and 40 between the front plate 10 and the rear plate 100.

In this case, as schematically illustrated in FIG. 4, the inner girder plate 30 may also be simultaneously buckled, the front plate 10 may be leveraged with reference to the hinge center Hc (e.g., the center of a seesaw), and the other girder plate 20 or 40 with respect to one end girder plate 40 or 20 connected thereto may be buckled to generate a tensile force Fex pulling a portion of the front plate 10, which is opposite thereto, and any one of the end girder plate 20 and 40, which is opposite thereto.

Therefore, in addition to the impact absorption by the buckling of the end girder plates 20 and 40, the absorption of tensile force against the impact force may be generated so that the absorption value of the impact energy is further increased.

That is, the impact force, which is transferred in the order of the starting reinforced part 12 of the front plate
the first buckling part 46 of the end girder plate 40 10→ the reinforced part 45→ the second buckling part 47→ the ending reinforced part 102 of the rear plate 100 in multiple stages, may be absorbed stepwise by the buckling generated as the front plate 10 moves toward the rear plate 100, and thus the impact transferred to a chassis of a vehicle may be dispersed over time.

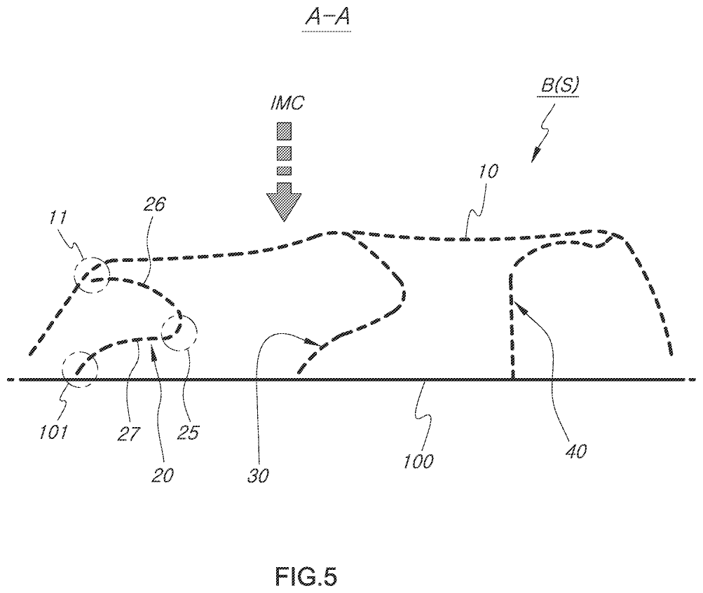

An impact test according a sectional strength analysis of a vehicle is carried out to the beam frame B according to the present disclosure, and collision impact as an impact center force IMC is applied to the portion of the frame B, which corresponds to the left part of FIG. 5. As the result, it has been identified that the shapes of the front plate 10, the end girder plates 20 and 40, the starting reinforced part 11 of the rear plate 100, the reinforced part 25, and end reinforced part 101 are generally maintained, and the first buckling part 26 and the second buckling part 27 are mostly buckled.

After applying the beam frame B of an exemplary embodiment of the present disclosure to a front bumper of a vehicle, the strength thereof is analyzed using the generally accepted test method.

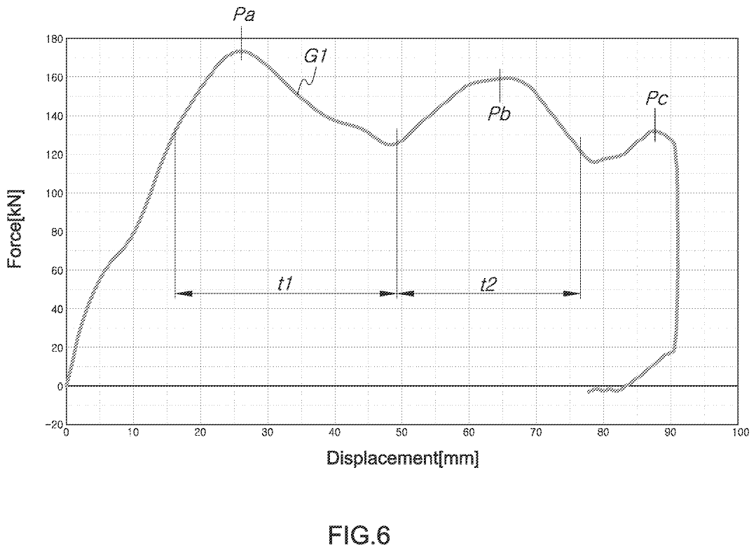

As in the graph G1 in FIG. 6 showing an entry displacement—a reaction force value of a trailer, as the impact absorption process of an exemplary embodiment of the present disclosure is stepwise carried out, it has been 0 identified that the reaction force induced in the beam frame B has stepwise peaks Pa, Pb, and Pc. This means that an impact force is dispersed over time and absorbed in multiple stages.

It is determined that the reason why the initial peak Pa and the middle peak Pb are widely spread over a relatively wide displacement range t1 and t2 is that the starting reinforced part 11 and the reinforced part 25 absorb a lot of energy, and also the inner girder plate 30 additionally absorbs energy while the front plate 10 is leveraged.

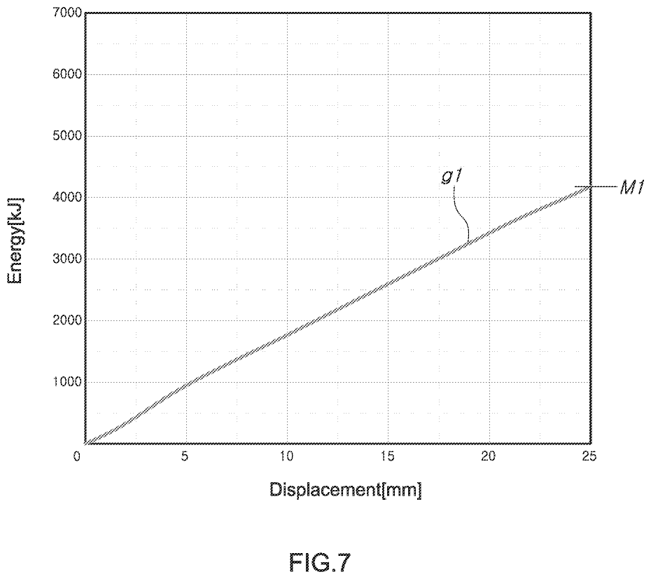

In addition, the graph g1 in FIG. 7, which illustrates an entry displacement—an energy absorption value of a trailer, shows the energy absorption value that gradually increases to a maximum value M1.

Therefore, the impact force may be dispersed for very short time and applied to a chassis of a vehicle so that the chassis of the vehicle is protected and the safety of a passenger is improved due to the distributed impact.

The beam frame B of an exemplary embodiment of the present disclosure may have the relatively simple sectional shape S compared to the configuration of the relative prior art.

Therefore, a material for extrusion may be easily dispersed so that not only the clogging of a die is minimized when the material is extruded out the die but also the power required for extrusion is reduced. Furthermore, this enables the extruded material to be uniformly processed in post-processes such as quenching, stretching, aging, and bending processes, thereby improving the quality thereof.

The beam frame B having a sectional shape S2 according to a modified example of an exemplary embodiment, which is modified while having the same technical feature as the end girder plates 20 and 40 and the center inner girder plate 30 between the front plate 10 and the rear plate 100 of an exemplary embodiment of the present disclosure.

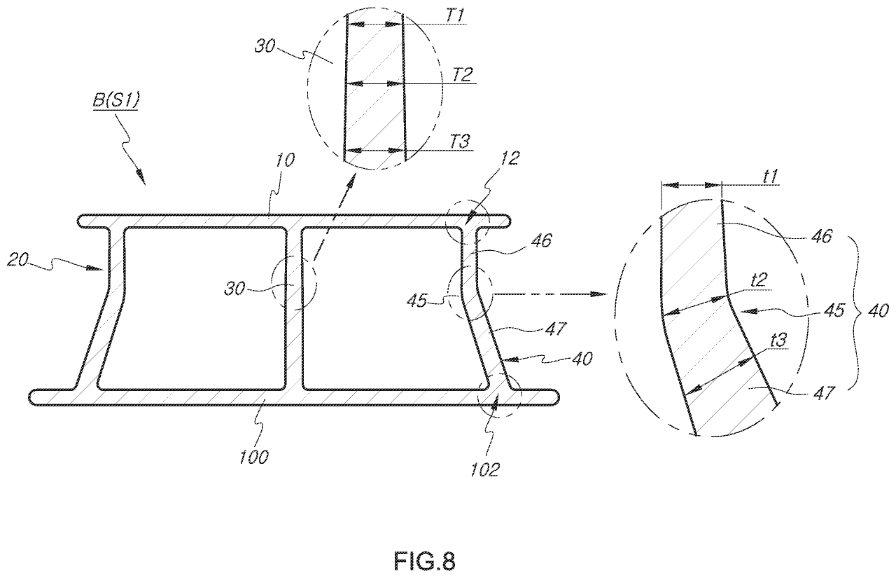

As illustrated in FIG. 8, the beam frame B having the sectional shape S2 may include the end girder plates 20 and 40 and the center inner girder plate 30 which are three connection bridges between the front plate 10 and the rear plate 100, and each of the end girder plates 20 and 40 and the inner girder plate 30 may have a sectional shape having a gradually linearly increasing thickness (t1->t2->t3) as each of the end girder plates 20 and 40 and the inner girder plate 30 extends and protrudes from the front plate to the rear plate 100.

The beam frame B may have a symmetrical shape, and the end girder plates 20 and 40 and the inner girder plate 30 may have shapes having thicknesses increasing at the same ratio. For the convenience of description, with reference to the enlarged right part of FIG. 8, only the end girder plate 40 will be described below.

The end girder plate 40 may be configured such that the thickness t1 of the first buckling part 46 having a plate shape, the thickness t2 of the reinforced part 45 having a plate shape, and the thickness t3 of the second buckling part 47 having a plate shape are gradually increased.

For example, as in FIG. 8, in a modified example of the present disclosure, the thickness t1 is 2.8 mm, the thickness t2 is 3.0 mm, and the thickness t3 is 3.2 mm, and the thickness of the beam frame B may increase linearly. The operation and effect will be described as follows.

In case that an impact force is applied to the front side of the beam frame B, the impact force transferred to the front plate 10 may be transferred to the rear plate 100 through the end girder plates 20 and 40 and the inner girder plate 30.

For convenience, only the right part of FIG. 8 will be described. Buckling in the starting reinforced part 12, in which the end girder plate 40 is in contact with the front plate 10, is relatively restricted, and the front plate 10 moves toward the rear plate 100.

The impact force is transferred to the starting buckling part 12 and the first buckling part 46 of the end girder plate 40, and then is transferred to the second buckling part 47 and the ending reinforced 102 while pulling the reinforced part 45. Therefore, the impact force is absorbed.

In addition, since the end girder plate 40 has an increasing thickness t1, t2, and t3, in the impact force transfer process, the energy absorption rate may be further increased as the buckling proceeds.

In addition, since the inner girder plate 30 has a gradually increasing thickness t1, t2, and t3, the impact force near the center C of the beam frame B may be linearly absorbed so that the amount of absorbed energy is further increased.

Although a graph of an entry displacement versus a reaction force according to the modified example is not illustrated, it may be obvious that peaks are respectively formed over entry displacement values increased than the peaks Pa, Pb, and Pc of the reaction force illustrated in the graph G1 of an entry displacement versus a reaction force according to the exemplary embodiment of the present disclosure.

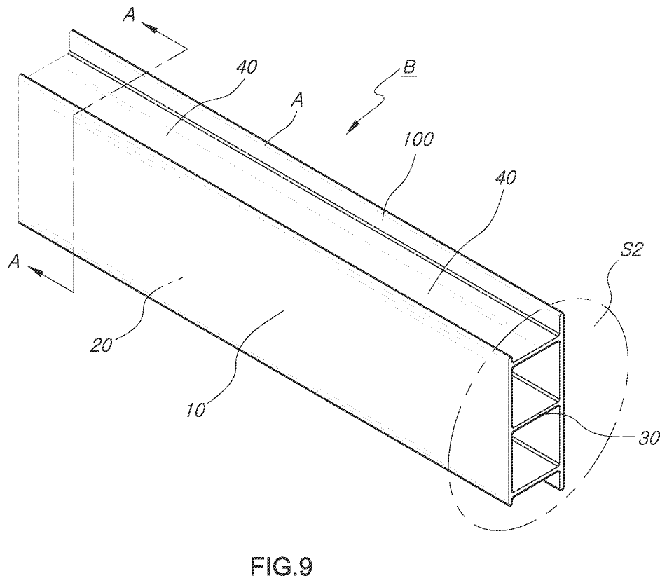

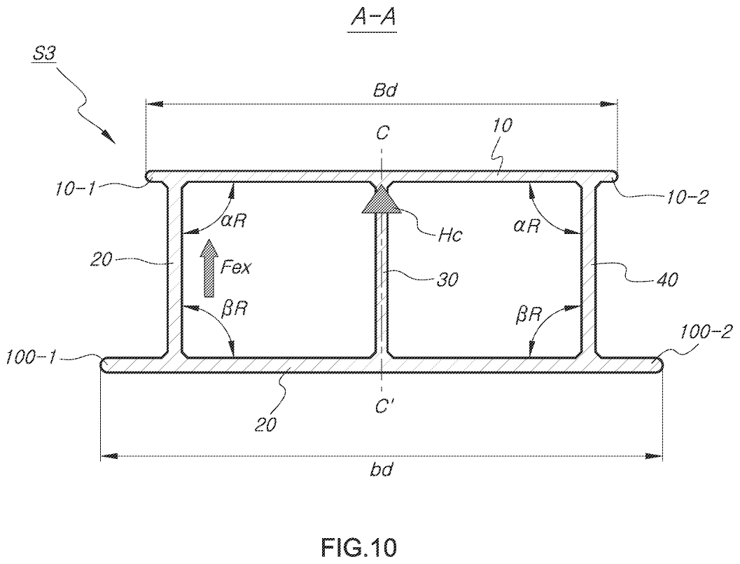

FIG. 9 is a partial perspective of a beam frame seen from the front side thereof according to another exemplary embodiment of the present disclosure, and FIG. 10 is a cross sectional view showing a sectional shape S3 thereof.

Another exemplary embodiment may have the same configurations as the exemplary embodiment, and may include the front plate 10, the rear plate 100, the end girder plates 20 and 40, and the inner girder plate 30. The end girder plates 20 and 40 and the inner girder plate 30 function as three connection bridges, the end girder plates and 40 are positioned at both sides thereof, and the inner girder plate 30 is positioned in the middle portion between the end girder plates. The end girder plates 20 20 and 40 may be positioned at both-sides with reference to a central point C of the width Bd of the front plate 10 so as to be spaced apart from each other, and may be formed integrally with each other while having a first connection angle αR which faces the central point C of the width Bd of the front plate 10 and is a right angle with respect to the front plate 10. That is, the first connection angle αR is an angle between the front plate 10 and an inner surface of the each of the end girder plates 20 and 40 and is a right angle.

That is, the connection angle α according to the exemplary embodiment of the present disclosure is selected within the range of a right angle to an acute angle, whereas the connection angle αR according to another exemplary embodiment is a right angle.

The end girder plates 20 and 40 according to another exemplary embodiment may extend from the front plate 10 to the rear plate 100 parallelly facing the front plate 10, and may be connected to the front plate 10 and the rear plate 100 to be left/right symmetric while having a second connection angle βR which faces the central point C′ of the width bd of the real plate 100 and is a right angle. That is, the second connection angle βR is an angle between the rear plate 100 and an inner surface of the each of the end girder plates 20 and 40 and is a right angle.

The end girder plates 20 and 40 and the inner girder plate 30 do not have a reinforced part against buckling, which is formed by the geometric shape formed due to the difference in the connection angles.

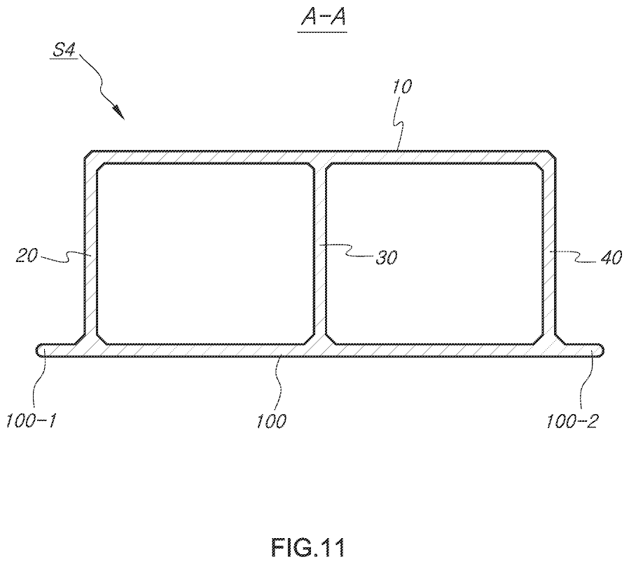

The end girder plates 20 and 40, which is integrally extruded and connect the front plate 10 and the rear plate 100, are connected to portions of the front plate 10 and the rear plate 100, the portions are selectable between opposite ends of each of the front plate 10 and the rear plate 100, and thus the end girder plates 20 and 40 are positioned inside the front plate 10 and the rear plate 100. Therefore, as illustrated in FIG. 9 and FIG. 10, each of the front plate 10 and the rear plate 100 may further include extension flanges 10-1 and 10-2 and 100-1 and 100-2 extending from the portions to outermost ends of each of the front plate 10 and the rear plate 100. However, as illustrated in FIG. 11, the front plate 10 may not include the extension flanges 10-1 and 10-2 and 100-1 and 100-2, the end girder plates 20 and 40 may be connected at the opposite ends of the front plate 10, and thus the front plate 10, the end girder plates 20 and 40, and the rear plate 100 may be formed in a closed polygon.

According to another exemplary embodiment, when an impact force is applied to the beam frame B having the sectional shape S3 from the front side, the impact force transferred to the front plate 10 is transferred to the rear plate 100 through the end girder plates 20 and 40 and the inner girder 30, and thus the end girder plates 20 and 40 and the inner girder plates 30 are buckled in an amorphous and unpredictable shape. At this time, in case that the impact force is biasedly applied to either of the left side or the right side the with reference to the central point C of the front plate 10, one of the end girder plates 20 and 40 is buckled by the impact force and leveraged around the inner girder plate as a hinge point, and thus is subjected to multi-stage buckling to absorb impact energy.

That is, as illustrated in FIG. 10, according to another exemplary embodiment which can be derived, the inner girder plate 30 is buckled while functioning as a hinge center Hc (e.g., the center of a seesaw). A tensile force Fex pulling a part of the front plate 10, which is leveraged and is opposite to the buckled part, may be applied to the other of the end girder plates 20 and 40 opposite to one of the end girder plates 20 and 40, which is buckled. Therefore, in addition to the absorption due to buckling, the absorption of tensile force against the impact force may be generated so that the absorption value of the impact energy is further increased.

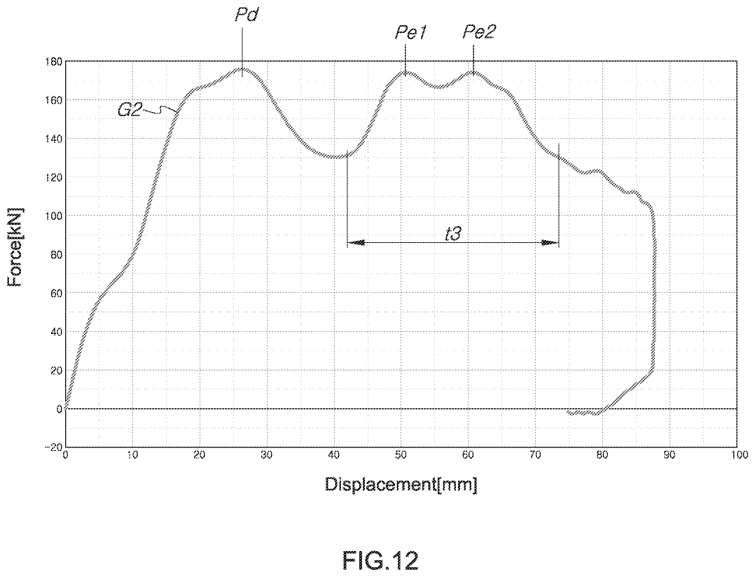

As in the graph G2 illustrated in FIG. 12 showing an entry displacement value—a reaction force, it is identified that a peak Pd of a reaction force by buckling of one of the end girder plates 20 and 40, and a peak Pe1 and a peak Pe2 of a reaction force due to buckling by a hinge action of the inner girder plate 30 are generated as multi-state peaks, and this means that an impact force is stepwise sequentially absorbed.

In the process of the absorption of the two-stage discontinuous impact force, since the peaks Pe1 and Pe2 of the reaction force by buckling by the hinge action of the inner girder plate 30 are absorbed in a wide range t3 of an entry displacement, it may be identified that the energy absorption value is increased by being leveraged with reference to the hinge center Hc. Therefore, the usefulness of the inner girder plate 30 may be demonstrated.

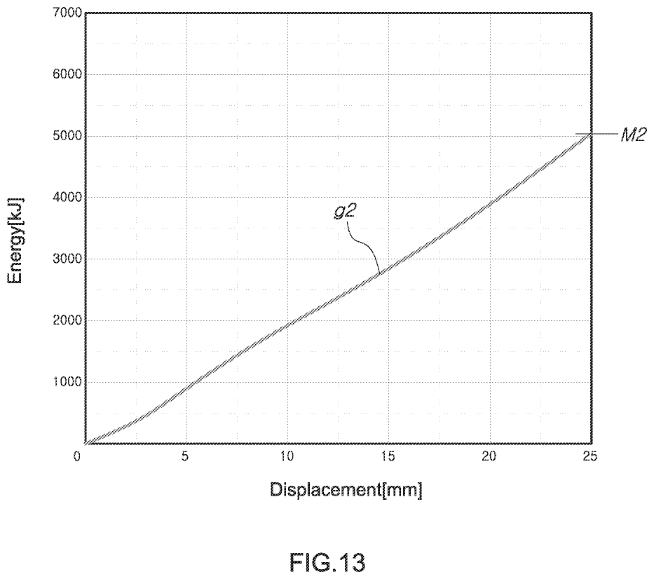

In addition, the graph g2 in FIG. 13 shows the maximum value M2 of energy absorption, which is increased than the maximum value M1 of energy absorption according to the exemplary embodiment.

The beam frame B according to another exemplary embodiment may also include the end girder plates 20 and 40 between the front plate 10 and the rear plate 100, and the inner girder plate 30 in the middle portion between the end girder plates 20 and 40, the end girder plates 20 and 40 and the inner girder plate 30 may function as three connection bridges, and each may have the first and the second connection angle αR and BR which are right angles. In addition, each of the end girder plates 20 and 40 and the inner girder plate 30 may be configured to have a sectional shape in which the thickness thereof linearly and gradually increases from the front plate 10 to the rear plate 100 so as to enable increased impact absorption.

For the convenience of description, the first connection angle αR and the second connection angle βR are separately described and illustrated, but it is obvious that the first connection angle R and the second connection angle βR are the same and are named as connection angle.

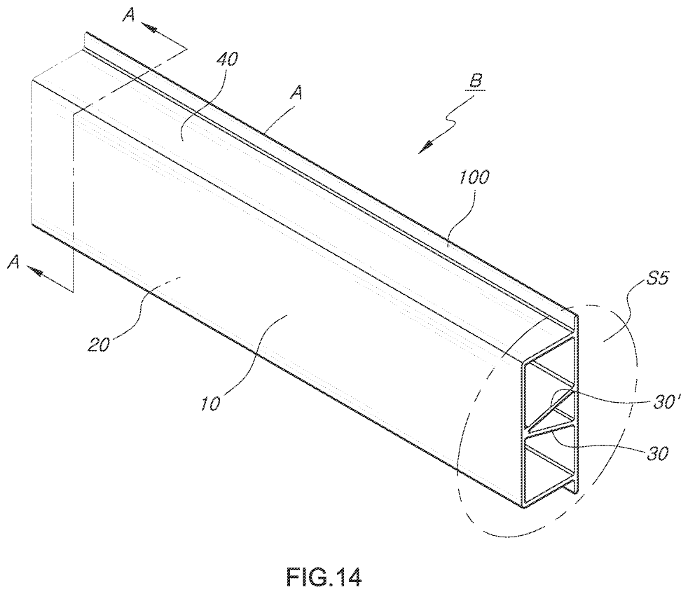

FIG. 14 is a partial perspective showing a sectional shape S5 of a beam frame B according to another exemplary embodiment of the present disclosure.

A beam frame B according to another exemplary embodiment may include a pair of inner girder plates 30 and 30′. The inner girder plates 30 and 30′ formed as a plate-shaped member may extend from a central point C of the front plate 10 toward a central point C′ of the rear plate 100, and may be integrally connected to the rear plate 100 while being spread with a spread angle δ selected in a range of 90 degrees or less.

The inner girder plates 30 and 30′ may form a hinge center Hc (e.g., the center of a seesaw) which is geometrically more rigid by the above configuration.

In case that an impact is applied to either of the left side or the right side with reference to the central point C of the front plate 10 of the beam frame B, one of the end girder plates 20 and 40 is buckled, and at the same time, the front plate 10 is leveraged with reference to the inner girder plates 30 and 30′ having increased strength as the hinge center Hc (e.g., the center of a seesaw), so that a tensile force Fex is generated. In addition, at the same time, the inner girder plates 30 and 30′ are buckled so that impact energy is absorbed while multiple peaks of a reaction force, which are increased over time, are formed.

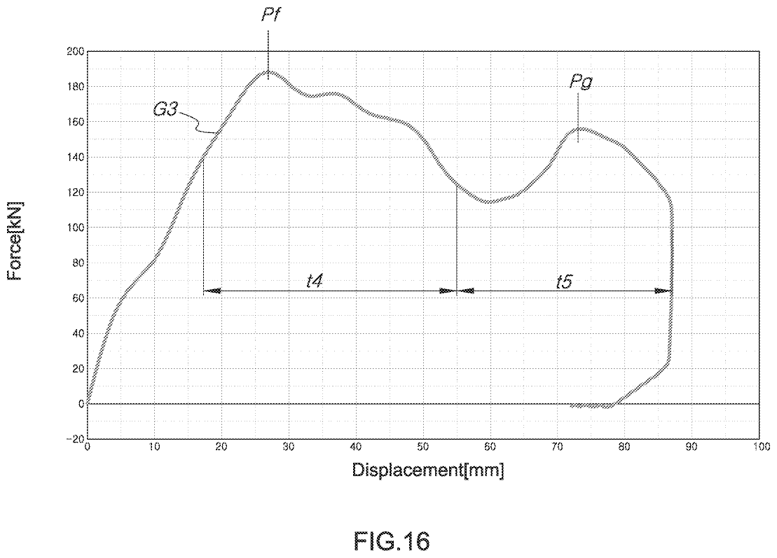

A graph G3 of an entry displacement value of—a reaction force in FIG. 16 shows two stage peaks of a peak Pf and a peak Pg of a reaction force generated in one of the end girder plates 20 and 40, among a reaction force generated in the end girder plates 20 and 40 and the inner girder plates 30 and 30′ at the time of impact.

Since the peak Pf and the peak Pg, which is generated by additional energy absorbed by the inner girder plates 30 and 30′, show peak shapes having a wide area over a longer displacement value tp4, it may be identified that an energy absorption value is increased by the inner girder plates 30 and 30′ having reinforced strength.

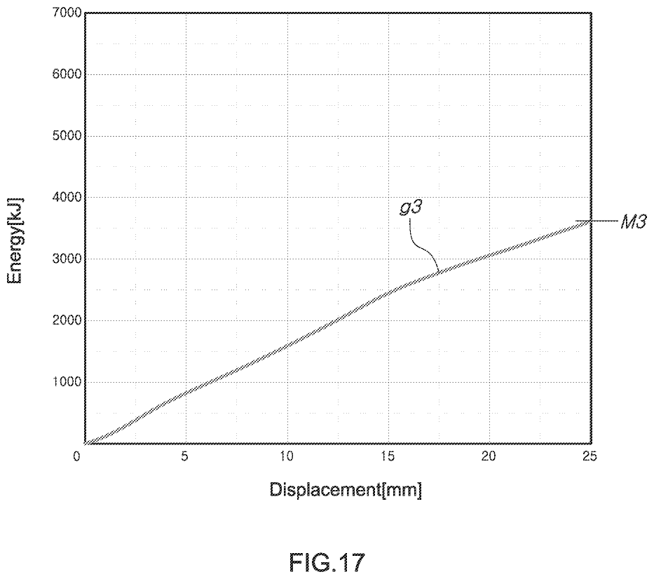

In addition, as in the graph g3 in FIG. 17, which illustrates an entry displacement—an energy absorption value of a trailer, the maximum value M3 of energy absorption gradually increases, but does not reach the maximum value M1 of energy absorption according to the exemplary embodiment.

The beam frame B according to another exemplary embodiment and another exemplary embodiment may also include the end girder plates 20 and 40 between the front plate 10 and the rear plate 100, and the inner girder plate 30 in the middle portion between the end girder plates 20 and 40, and each of the end girder plates 20 and 40 and the inner girder plate 30 may be configured to extend and protrude from the front plate 10 toward the rear plate 100 and may have a sectional shape in which the thickness of each of the plates gradually increases.

The characteristics of the present disclosure related to the main technical idea of the present disclosure will be described through an experimental comparison of the present disclosure and the bumper beam PB having the sectional shape PS, which is described above and is a relative prior art to be compared.

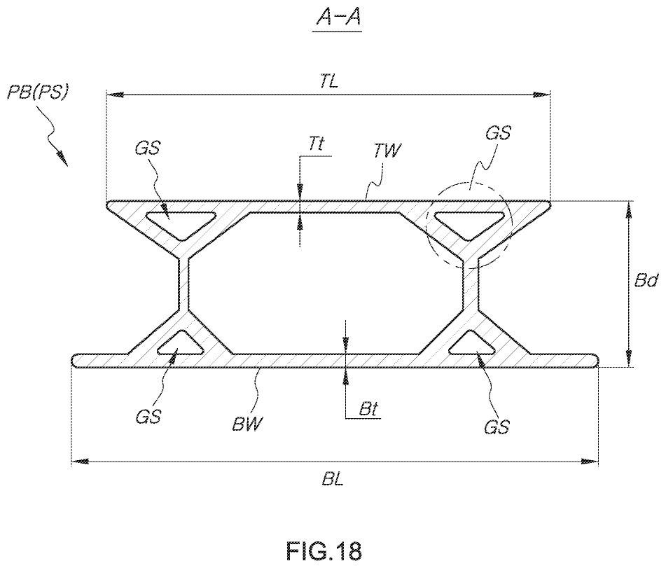

FIG. 18 is a cross sectional view of a relative prior art. As illustrated in FIG. 18, a top wall TW, a bottom wall BW, and connection bodies between the top wall TW and the bottom wall BW are provided. Each of the connection bodies are provided with a first and a second geometrical structure GS which have a cross-sectional triangular shape and are provided as the connection bodies, respectively.

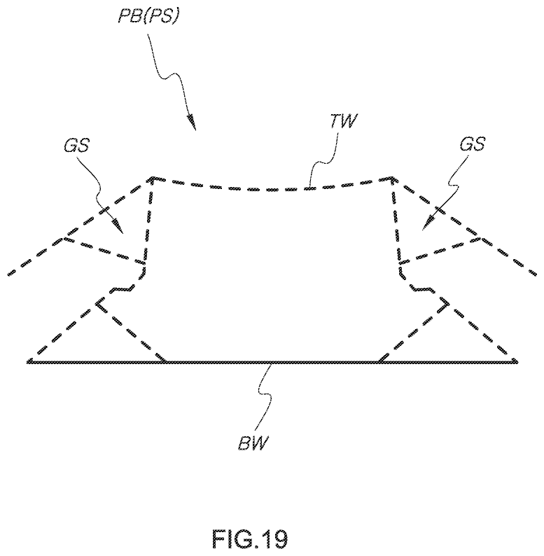

As a result of an RCAR impact test of the bumper beam PB, the bucking shape thereof is illustrated in FIG. 19. Through this, it is identified that the first and the second geometric structure GS, which are reinforcing parts connecting the top wall TW and the bottom wall BW and have relatively increased strength compared to other parts, are buckled while the shapes thereof are maintained.

As illustrated in FIG. 18, the actual specification of the product, to which the bumper beam PB is applied, is as follows: the thickness Tt of the top wall TW is 2.3 mm, the length TL in the width thereof is 104 mm, the thickness Bt of the bottom wall is 2.3 mm, the length BL in the width thereof is 125 mm, the distance Bd between the top wall TW and the bottom wall BW is 45 mm, and the weight thereof is 2,692 g.

The beam frames B according exemplary embodiments and modified examples of the present disclosure, which are manufactured the same specification as the bumper beam PB, are tested according to RCAR regulations.

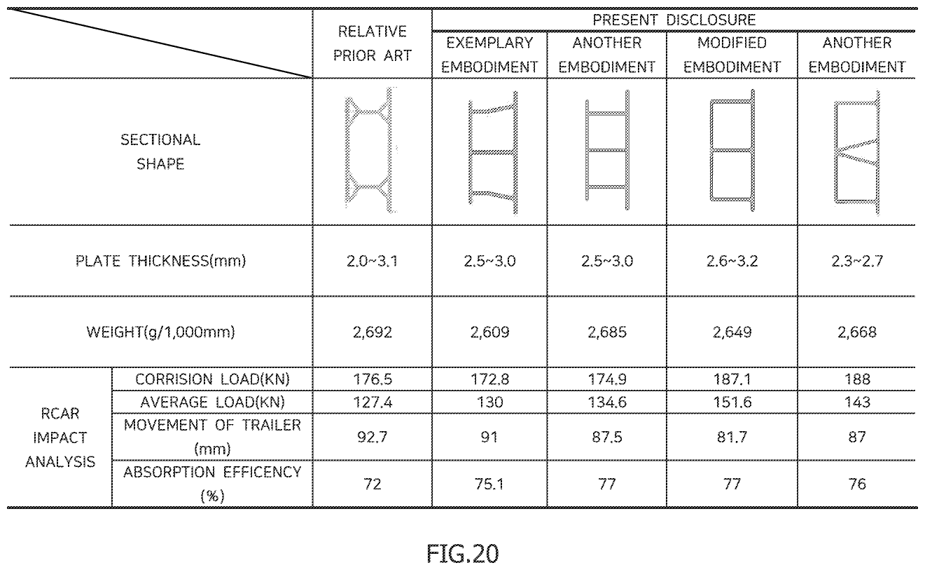

The table in FIG. 20 shows the result of the RCAR impact test of the beam frames B according to the exemplary embodiments and modified examples of the present disclosure and the bumper beam PB.

The beam frame B of the exemplary embodiment of the present disclosure, which is applied to a front bumper of a vehicle, has been tested under the condition of a collision speed of 15.5 KPH and an evaluation weight of 13,799 Kg according to the RCAR regulations, and a collision load, an average load, a movement amount (intrusion) of a trailer, and an absorption efficiency values have been measured. The beam frame B of the exemplary embodiment of the present disclosure has a weight of 2,609 g per 1,000 mm in length, and according to the RCAR impact analysis of the beam frame B, the collision load is 172.8 KN, the average load is 130 KN, the movement amount of a trailer is 91 mm, and the efficiency of energy absorption is 75.1%. The efficiency of energy absorption is a value obtained by dividing the actual amount of absorbed energy by the products of the maximum load and maximum deformation amount of a vehicle.

As in the table in FIG. 20, through the test values, it is identified that the bumper beam P of the exemplary embodiment of the present disclosure has a reduced weight and absorption efficiency of energy higher about 3.1%, compared to the bumper beam PB of the relative prior art.

In addition, through the test values, it is identified that the bumper beams B of the exemplary embodiments and modified examples of the present disclosure have a significantly reduced weight and amount of movement of a trailer compared to the relative prior art, a value of the collision load in the RCAR collision analysis test, which is higher than or almost the same as the bumper beam PB of the relative prior art, and efficiency of energy absorption higher than the bumper beam PB of the relative prior art.

What is claimed is:

1. A beam frame for a bumper back beam of a vehicle, the beam frame comprising:
a front plate and a rear plate which have a plate shape and are spaced in parallel to each other;
a pair of end girder plates which function as connection bridges for integrally connecting the front plate and the rear plate, each of the end girder plates being bent and being connected to the front plate at a first connection angle therebetween and connected to the rear plate at a second connection angle therebetween, the first connection angle being an angle between the front plate and an inner surface of the each of the end girder plates and being an angle selected in a range between a right angle and an obtuse angle, the second connection angle being an angle between the rear plate and the inner surface and being an angle selected in a range between a right angle and an acute angle, the inner surface facing a central point of the width of the front plate and a central point of the width of the rear plate; and
an inner girder plate disposed between the end girder plates, connected to the central point of the width of the front plate at a right angle, and connected to the central point of the width of the rear plate at a right angle.

2. The beam frame of claim 1, wherein each of the end girder plates and the inner girder plate extends from the front plate to the rear plate, and comprises a plate-shaped part having a gradually increasing thickness.

3. The beam frame of claim 1, wherein the end girder plates connecting the front plate and the rear plate are connected to portions of the front plate and the rear plate, the portions being selectable between opposite ends of each of the front plate and the rear plate, so that each of the front plate and the rear plate comprises extension flanges extending from the portions to outermost ends of each of the front plate and the rear plate.

4. The beam frame of claim 1, wherein each corner of the branch portion where the pair of end girder plates, the inner girder plate, the front plate and the rear plate meet and is integrally molded, further has a rounded curvature portion R.

5. A beam frame for a bumper back beam of a vehicle, the beam frame comprising:
a front plate and a rear plate which have a plate shape and are spaced apart in parallel to each other;
a pair of end girder plates which function as connection bridges for integrally connecting the front plate and the rear plate, each of the end girder plates being bent and being connected to the front plate at a first connection angle therebetween and connected to the rear plate at a second connection angle therebetween, the first connection angle being an angle between the front plate and an inner surface of the each of the end girder plates and being an angle selected in a range between a right angle and an obtuse angle, the second connection angle being an angle between the rear plate and the inner surface and being an angle selected in a range between a right angle and an acute angle, the inner surface facing a central point of the width of the front plate and a central point of the width of the rear plate; and
an inner girder plate disposed between the end girder plates, connected to a central point of the width of the front plate at a right angle, and connected to a central point of the width of the rear plate at a right angle,
wherein each of the end girder plates comprises a reinforced part which is disposed between the front plate and the rear plate and at which said each of the end girder plates is bent, a first buckling part extending from the front plate to the reinforced part, and a second buckling part extending from the rear plate to the reinforced part,
each of the end girder plates is bent at the reinforced part at a bent angle which is larger than 180 degrees at an inside thereof facing the inner girder plate, and
each of the first buckling part and the second buckling part has a shape of a plate.

6. The beam frame of claim 5, wherein each of end girder plates and the inner girder plate extends from the front plate to the rear plate, and comprises a plate-shaped part having a linearly increasing thickness.

7. The beam frame of claim 5, wherein the end girder plates connecting the front plate and the rear plate are connected to portions of the front plate and the rear plate, the portions being selectable between opposite ends of each of the front plate and the rear plate, so that each of the front plate and the rear plate comprises extension flanges extending from the portions to outermost ends of each of the front plate and the rear plate.

8. A beam frame for a bumper back beam of a vehicle, the beam frame comprising:
a front plate and a rear plate which have a plate shape and are spaced apart in parallel to each other;
a pair of end girder plates which function as connection bridges for integrally connecting the front plate and the rear plate, each of the end girder plates being connected to the front plate at a right angle and connected to the rear plate at a right angle; and
an inner girder plate disposed between the end girder plates, connected to a central point of the width of the front plate at a right angle, and connected to a central point of the width of the rear plate at a right angle.

9. The beam frame of claim 8, wherein each of the end girder plates and the inner girder plate extends from the front plate to the rear plate, and comprises a plate-shaped part having a linearly increasing thickness.

10. The beam frame of claim 8, wherein the end girder plates connecting the front plate and the rear plate are connected to portions of the front plate and the rear plate, the portions being selectable between opposite ends of each of the front plate and the rear plate, so that each of the front plate and the rear plate comprises extension flanges extending from the portions to outermost ends of each of the front plate and the rear plate.

11. The beam frame of claim 8, wherein each corner of the branch portion where the pair of end girder plates, the inner girder plate, the front plate and the rear plate meet and is integrally molded, further has a rounded curvature portion R.

12. A beam frame for a bumper back beam of a vehicle, the beam frame comprising:
a front plate and a rear plate which have a plate shape and are spaced apart in parallel to each other;
a pair of end girder plates which function as connection bridges for integrally connecting the front plate and the rear plate, each of the end girder plates being connected to the front plate at a right angle and connected to the rear plate at a right angle; and
a pair of inner girder plates configured to extend from a central point of the width of the front plate toward a central point of the rear plate, and integrally connected to the rear plate while being spread at a spread angle selected from 90 degrees or less.

13. The beam frame of claim 12, wherein each of the end girder plates and the inner girder plate extends from the front plate to the rear plate, and comprises a plate-shaped part having a linearly increasing thickness.

14. The beam frame of claim 12, wherein the end girder plates connecting the front plate and the rear plate are connected to portions of the front plate and the rear plate, the portions being selectable between opposite ends of each of the front plate and the rear plate, so that each of the front plate and the rear plate comprises extension flanges extending from the portions to outermost ends of each of the front plate and the rear plate.

15. The beam frame of claim 12, wherein each corner of the branch portion where the pair of end girder plates, the inner girder plate, the front plate and the rear plate meet and is integrally molded, further has a rounded curvature portion R.
